(19) United States
(12) Patent Application Publication
(10) Pub. No.: US 2006/0227721 A1
(43) Pub. Date: Oct. 12, 2006

(54) Content transmission device and content transmission method

(76) Inventors: Junichi Hirai, Suita city (JP); Keiji Sugiyama, Joyo city (JP); Masashi Takemura, Osaka city (JP)

Correspondence Address: WENDEROTH, LIND & PONACK L.L.P., 2033 K. STREET, NW, SUITE 800, WASHINGTON, DC, 20006, US

(21) Appl. No.: 10/567,687

(22) PCT Filed: Nov. 24, 2004
(86) PCT No.: PCT/JP04/17378

§ 371 Date: Feb. 9, 2006

(51) Int. Cl. H04L 12/28

(52) U.S. Cl. 370/254

(57) ABSTRACT

An object of the present invention is to provide a content transmission device which allows playback of content on a content receiving device, the viewing and/or listening of which was interrupted on the content receiving device. A content transmission device is provided which is connected with a content receiving device 102 through a network and comprises: a storage unit 1013 for storing content; a transmitting and receiving unit 1014 for transmitting content to the content receiving device 102; a reception status monitoring unit 1015 for capturing an interruption location at which the content receiving device 102 became unable to receive content, or an interruption location at which the user of the content receiving device 102 interrupted viewing and/or listening; and a transmission control unit 1017 for controlling the transmitting and receiving unit 1014, so that the content of the storage unit 1013 is sent to the content receiving device 102, based on the interruption location captured by the reception status monitoring unit 1015.

### TECHNICAL FIELD

The present invention relates to a content transmission device and content transmission method.

### BACKGROUND ART

Services providing high speed network connections for mobile terminals, such as third generation portable telephone network and hot spot services using wireless LAN technology, have spread in recent years. In the future, high speed and low cost network connection functions will be included in portable telephones and mobile terminals such as PDAs (Personal Digital Assistants), car navigation devices, and the like. Thus, it is thought that it will become possible to use these terminals as content receiving devices capable of receiving streaming content such as images, sound, and the like and easily view and/or listen to streaming content such as the received images, sound, and the like at a destination point.

In a mobile computing environment, however, the situation in the user's surroundings can often change rapidly, for example, someone may suddenly call out or the user may approach some obstacle. Cases may therefore occur wherein the user misses part of the content. As a method for eliminating this missing of content, the television receiving device in Patent Reference 1, for example, is provided with storage means such as a hard disk and compresses and temporarily stores on the storage means in the television receiving device a video signal received from a broadcast station or the like. The users can then view and/or listen to the content starting with the missed portion by reading and displaying the stored video signal from a playback location specified by the user himself. With this television receiving device in Patent Reference 1, the user can view and/or listen to a program from the beginning, by reading and displaying the video signal stored in the storage means, even if, for example, the initial part of the program has been missed.

In a mobile computing environment, however, it is difficult to maintain a stable network connection continuously in some situations because of the use of wireless communications for communicating with a content receiving device. For example, cases may occur where radio reception suddenly becomes poor, such as when the content receiving device enters the shadow of a building or a tunnel, and the network connection is temporarily cut off. Accordingly, cases will occur in which content reception by the content receiving device is cut off and the user misses part of the content. In such a case, when the television receiving device recited in Patent Reference 1 cannot receive content because of bad reception, the user cannot play back the content that could not be received and was missed. Also, because the user himself must select the playback position for the video signal, users cannot quickly return to and view and/or listen to the missed portion.

Patent Reference 1:

JP-H07-250305-A

### DISCLOSURE OF THE INVENTION

In order to solve the problems, an object of the present invention is to provide a content transmission device which makes possible playing back of content on a content receiving device, the viewing and/or listening of which was interrupted on the content receiving device.

In order to solve the problems, the first invention is a content transmission device which connects with a content receiving device through a network, comprising a storage unit configured to store content, a transmission unit configured to transmit content to the content receiving device, an interruption location capturing unit configured to capture the interruption location when the content receiving device becomes unable to receive the content or the interruption location at which the user of the content receiving device interrupted viewing and/or listening with the content receiving device, and a transmission controlling unit configured to control the transmission unit so as to transmit the content in the storage unit to the content receiving device based on the interruption location captured by the interruption location capturing unit.

When the content receiving device fails to receive content, the content transmission device transmits the content corresponding to the interruption location at which the reception failure occurred to the content receiving device. Alternatively, when the user of the content receiving device interrupts viewing and/or listening of content with the content receiving device, the content transmission device transmits, to the content receiving device, the content corresponding to the interruption location at which viewing and/or listening was interrupted. Accordingly, the user viewing and/or listening to the content with the content receiving device, or the content receiving device and content transmission device can instantly play back the content corresponding to the interruption location on the content receiving device without searching for the interruption location. The user of the content receiving device can therefore instantly resume viewing and/or listening to content, starting from the interruption location, and can also view and/or listen to interrupted content during short intervals of free time, such as while waiting for a train.

Because the content transmission device transmits content corresponding to the interruption location to the content receiving device, the content receiving device can play back content which could not be received or content interrupted by the user, just by playing back received content. In effect, it is not necessary for the content receiving device to store content, or to search the stored content for content corresponding to the interruption location. It is thereby possible to improve convenience for the user using the content receiving device without increasing the complexity of the constitution of the content receiving device.

For example, when the content receiving device is a mobile terminal, reception is unstable, as the reception environment of the mobile terminal changes at any time, and failures in content reception often occur. Also, the user of the mobile terminal is inevitably interrupted during the viewing and/or listening to content with the mobile terminal due to the constant change of the usage environment of the mobile terminal. In such a case as well, viewing and/or listening can be resumed starting from the interruption location in the content transmission device without the content transmission device, content receiving device, or the user himself searching for the interruption location. As described above, by virtue of the invention set forth above, a content transmission device can be provided, which is optimal for the usage environment of a mobile terminal.

The second invention provides a content transmission device according to the first invention, wherein the interruption location capturing unit further comprise a status monitoring unit configured to receive and monitor the status of the content receiving device from the content receiving device, while capturing the interruption location based on the status.

In the content transmission device, managing the status of the content receiving device is made easy through combining status monitoring, such as of the reception status and operating status of the content receiving device, with capturing the interruption location.

The third invention provides a content transmission device according to the second invention, wherein the status monitoring unit receives, from the content receiving device, notification that content reception has become unable, and captures the interruption location based on the notification.

The fourth invention provides a content transmission device according to the second invention, wherein the status monitoring unit detects whether the error rate of communication with the content receiving device has exceeded a predetermined value, and capture the interruption location based on those detection results.

The fifth invention provides a content transmission device according to the second invention, wherein the status monitoring unit detects whether the communication of the content transmission device with the content receiving device has been cut off, and captures the interruption location based on those detection results.

The sixth invention provides a content transmission device according to the first invention, wherein the interruption location capturing unit captures the interruption location based on the time at which the content receiving device became unable to receive content, or the time at which the user of the content receiving device interrupted viewing and/or listening with the content receiving device.

When the interruption location is captured based on time, the transmission controlling unit can transmit content to the content receiving device based on that time.

The seventh invention provides a content transmission device according to the first invention, wherein the content comprises multiple chapters, and the interruption location capturing unit captures the interruption location in chapter units.

When the interruption location is captured according to the chapter, the transmission controlling unit can transmit content to the content receiving device based on that chapter. Here, “chapters” are the predetermined blocs into which a program, which is a unit bloc comprising content such as image data, sound data, and the like, and which is broadcast for television or the like, is divided.

The eighth invention provides a content transmission device according to the first invention, wherein the transmission controlling unit controls the transmission unit so as to transmit content starting from the interruption location to the content receiving device.

Because the content transmission device transmits content to the content receiving device, starting from the interruption location, the playback of content starting from the interruption location on the content receiving device can be resumed instantly, without the content transmission device, content receiving device, the user himself, or the like, searching for the interruption location.

The ninth invention provides a content transmission device according to the first invention, wherein the transmission controlling unit controls the transmission unit so as to transmit content to the content receiving device starting from a location in advance, by a predetermined amount, of the interruption location.

Because the content transmission device transmits content from prior to the interruption location to the content receiving device, the user of the content receiving device can view and/or listen to content while grasping the flow of the content before and after the interruption location.

The tenth invention provides a content transmission device according to the first invention, wherein the content comprises a plurality of chapters; the interruption location capturing unit captures as the interruption location the chapter including the location at which the content receiving device became unable to receive content or the location at which the user of the content receiving device interrupted viewing and/or listening with the content receiving device; and the transmission controlling unit controls the transmission unit so as to transmit content to the content receiving device from the beginning of the chapter captured by the interruption location capturing unit.

Because the content transmission device transmits, to the content receiving device, content starting from the beginning of the chapter in which viewing and/or listening was interrupted, the user of the content receiving device can view and/or listen to content from a place with a better stopping point than would be the case when transmitting content starting from the location at which viewing and/or listening was interrupted.

The eleventh invention provides a content transmission device according to the first invention, wherein the interruption location capturing unit captures the interruption reason for which the content receiving device became unable to receive content, or the interruption reason for which the user of the content receiving device interrupted viewing and/or listening with the content receiving device; and the transmission controlling unit determines the predetermined location to retrace from the interruption location according to the interruption reason, and controls the transmission unit so as to transmit content to the content receiving device starting from the predetermined location determined.

For example, when the interruption reason is interruption due to a telephone call, the transmission controlling unit determines a location retraced by a relatively long way from the interruption location, and transmits the content by that determined amount to the content transmission device. When the user interrupts content that is being viewed and/or listened to with the content receiving device due to a telephone call, the user is very likely to forget the content that was viewed and/or listened to prior to the telephone call. With the content transmission device transmitting content far prior to the interruption location, the user can view and/or listen to content while grasping the flow of the content before and after the interruption location. Determining the predetermined location to retrace from the interruption location according to the interruption reason can provide improved convenience when the user uses the content receiving device.

The twelfth invention provides a content transmission device according to the first invention, further comprising a receiving unit configured to receive content from the exterior, and a memory controlling unit configured to perform control so that content received by the receiving unit is stored in the storage unit starting from the interruption location captured by the interruption location capturing unit.

When reception with the content receiving device is normal, content received by the receiving unit of the content transmission device is transmitted to the content transmission device without being stored. Meanwhile, the content transmission device transmits to the content receiving device the content which is saved and stored in the storage unit starting from the interruption location at which reception by the content receiving device failed or the user interrupted the viewing and/or listening of the content. The memory capacity used by the storage unit can thereby be reduced.

The thirteenth invention provides a content transmission device according to the twelfth invention, wherein the memory controlling unit performs control so that the transmission unit transmits content to the content receiving device based on the interruption location, while the storage unit stores content received by the receiving unit.

When the content receiving device receives content based on the interruption location, the content transmission device cannot transmit to the content receiving device content which is continuously received by the receiving unit from a broadcast station or the like. Content received by the receiving unit is therefore stored in the storage unit while content based on the interruption location is being transmitted. When the transmission of content based on the interruption location ends, the content transmission device transmits to the content receiving device the content stored in the storage unit during that transmission. Accordingly, after viewing and/or listening to content transmitted on the basis of the interruption location, the user of the content receiving device can view and/or listen to content received by the content transmission device from a broadcast station or the like during that interval.

The fourteenth invention provides a content transmission device according to the second invention, wherein the status monitoring unit detects whether the content receiving unit has become able to receive or play back content and notify the transmission controlling unit of the detection results; and the transmission controlling unit controls the transmission unit so as to transmit the content in the storage unit to the content receiving device based on the detection results.

With the status monitoring unit detecting whether the content receiving device has become able to receive content, the content transmission device can automatically send content corresponding to the interruption location to the content receiving unit in response to that detection.

The fifteenth invention provides a content transmission device according to the second invention, wherein the status monitoring unit notifies the transmission controlling unit of the transmission request upon receiving a request from the content receiving device for transmission from the interruption location; and the transmission controlling unit controls the transmission unit so as to transmit the content in the storage unit to the content receiving device based on the notification of the transmission request.

With the status monitoring unit receiving a transmission request from the content receiving device, the content transmission device can transmit content corresponding to the interruption location to the content receiving unit in response to that transmission request. The user of the content receiving device can thereby instantly view and/or listen to content starting from the interruption location without needing to search for the interruption location.

The sixteenth invention provides a content transmission method for a content transmission device connected with a content receiving device over a network, which is a content transmission method comprising a storage step for storing content, a transmission step for transmitting content to the content receiving device, an interruption location capture step for capturing the interruption location at which the content receiving device became unable to receive content or the user of the content receiving device interrupted viewing and/or listening with the content receiving device, and a transmission control step for controlling the transmission of content stored in the storage step to the content receiving device based on the interruption location captured in the interruption location capture step.

### BRIEF DESCRIPTION OF THE DRAWINGS

FIG. 1 is a block diagram showing a content transmitting and receiving system 100 according to a first embodiment of the present invention.

FIG. 2A is a descriptive drawing (1) showing a method for capturing the interruption location.

FIG. 2B is a descriptive drawing (2) showing a method for capturing the interruption location.

FIG. 2C is a descriptive drawing (3) showing a method for capturing the interruption location.

FIG. 2D is a descriptive drawing (4) showing a method for capturing the interruption location.

FIG. 3A shows sample data when capturing the interruption location according to absolute time or relative time.

FIG. 3B shows sample data when capturing the interruption location according to chapters.

FIG. 4A is a descriptive drawing showing the interruption location for terminal A in FIG. 3A and the transmission location at which the transmitting and receiving unit starts transmitting content.

FIG. 4B is a descriptive drawing showing the interruption location for the terminal A in FIG. 3B and the transmission location.

FIG. 4C is a descriptive drawing showing the interruption location for the terminal A of FIG. 3A and the transmission location at which the transmitting and receiving unit starts transmitting content.

FIG. 4D is a descriptive drawing showing the interruption location for the terminal A of FIG. 3A and the transmission location at which the transmitting and receiving unit starts transmitting content.

FIG. 4E is a descriptive drawing showing a transmission location at which content transmission starts.

FIG. 5 is an example of a flowchart showing the flow of content transmission in the content transmitting and receiving system.

FIG. 6 is a block diagram showing a content transmitting and receiving system 200 according to a second embodiment of the present invention.

FIG. 7 is a block diagram showing a content transmitting and receiving system 300 according to a third embodiment of the present invention.

### EXPLANATION OF THE REFERENCE SYMBOLS

101, 201, 301: Content transmission device
102, 202, 302: Content receiving device
103, 203, 303: Content distribution device
120, 220, 225, 320: Wireless communications network
204: Relay device
1011, 2011, 3011: Receiving unit
1012, 2012, 3012: Memory control unit
1013, 2013, 3013: Storage unit
1015, 2045, 3025: Status monitoring unit
1016, 2046, 3026: Interruption location memory unit
1017, 2017, 3017: Transmission control unit
2018, 3018: Interruption location receiving unit

### BEST MODE FOR CARRYING OUT THE INVENTION

### First Embodiment

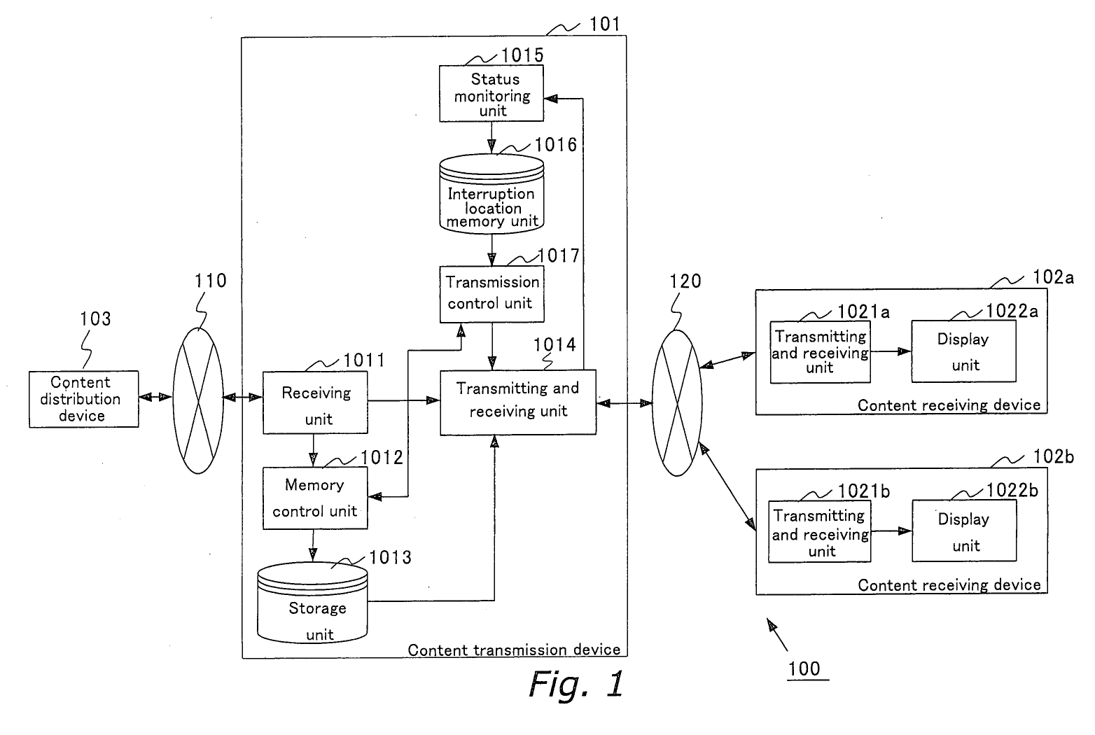

FIG. 1 is a block diagram showing a content transmitting and receiving system 100 according to a first embodiment of the present invention.

(1) Overall Constitution

The content transmitting and receiving system 100 comprises a content transmission device 101, content receiving device (102a, 102b, etc.)102, and a content distribution device 103. The content distribution device 103 is connected with the content transmission device 101 through a communications network 110. The content transmission device 101 and the content receiving device 102 are connected via a wireless communications network 120.

The content distribution device 103 transmits content such as television programs, radio programs, and the like to the content transmission device 101 via the communications network 110. The content transmission device 101 transmits content received from the content distribution device 103 to each content receiving device 102 via the wireless communications network 120. When the content receiving device 102 cannot receive content transmitted from the content transmission device 101, the content transmission device 101 transmits content to the content receiving device 102 based on the interruption location at which reception became impossible. Alternatively, when the user of the content receiving device 102 interrupts the viewing and/or listening of content with the content receiving device 102, the content transmission device 101 transmits the content based on that interruption location to the content receiving device 102.

The constitutions of the content transmission device 101, content receiving device 102, and the content distribution device 103 are described in detail below.

(2) Content Distribution Device

The content distribution device 103 is a satellite or terrestrial broadcast station, or CATV (Cable Television) station, and is connected with the content transmission device 101 over the communications network 110. The communications network 110 comprises a satellite communications network using communications satellites or the like, when the content distribution device 103 is a satellite content distribution device, a terrestrial communications network using towers when the content distribution device 103 is a terrestrial content distribution device, and an optic fiber network when the content distribution device 103 is a CATV station. The content distribution device 103 transmits, to the content transmission device 101, over the communications network 110, content such as television programs, radio programs, or the like, broadcast by the content distribution device 103.

The content distribution device 103 may also be a data distribution company distributing content over the network, and may stream content to the content transmission device 101 over a communications network 110 comprising the Internet.

(3) Content Transmission Device

Next, the content transmission device 101 is described in detail. The content transmission device 101 comprises a receiving unit 1011, a memory control unit 1012, a storage unit 1013, a transmitting and receiving unit 1014, a status monitoring unit 1015, an interruption location memory unit 1016, and a transmission control unit 1017. Examples of the content transmission device 101 include a home server, hard disk recorder with communications capabilities, or the like.

The content transmission device 101 receives and stores content from the content distribution device 103, while transmitting the received content to the content transmission device 102. The content transmission device 101 captures the interruption location at which the content receiving device 102 could not receive content and interruption location at which the user interrupted viewing and/or listening, and transmits content to the content receiving device 102 based on the interruption location.

Next, each of the elements constituting the content transmission device 101 are described in detail.

(3-1) Receiving Unit

The receiving unit 1011 is a television tuner, radio tuner, or the like, and receives content distributed by the content distribution device 103.

(3-2) Memory Control Unit

The memory control unit 1012 controls recording of content received by the receiving unit 1011 to the storage unit 1013. For example, the memory control unit 1012 comprises hardware and software for digital encoding based on a system for the compression and encoding of video and audio signals such as the MPEG2 standard, MPEG4 standard, or the like, when recording an analog television broadcast or the like. The encoding system used when recording content is not limited to MPEG2 and MPEG4. The memory control unit 1012 may also be constructed to record content without further processing in the case where the content received by the receiving unit 1011 is digitally encoded in advance, such as content streamed through the Internet or the like, or from digital broadcasting services.

The memory control unit 1012 may control so that all the content received by the receiving unit 1011 is stored in the storage unit 1013, or may control so that the content from interruption location is stored in the storage unit 1013 when instructed by the transmission control unit 1017, described below. When content from the interruption location is stored in the storage unit 1013, the amount of memory used by the storage unit 1013 can be reduced.

Furthermore, the memory control unit 1012 controls so that content received by the receiving unit 1011 is recorded in the storage unit 1013 in parallel with the transmitting and receiving unit 1014 transmitting content to the content receiving device 102 based on the interruption location. When the content receiving device 102 receives content from the interruption location, the content continuously received by the content transmission device 101 from the content distribution device 103 cannot be transmitted to the content receiving device 102. Content received by the receiving unit 1011 is therefore stored in the storage unit 1013 while content based on the interruption location is being transmitted. When the transmission of content based on the interruption location ends, the content transmission device 101 transmits to the content receiving device 102 the content stored in the storage unit 1013 during that transmission. Accordingly, after viewing and/or listening to content transmitted on the basis of the interruption location, the user of the content receiving device 102 can view and/or listen to content received by the content transmission device 101 from the content distribution device 103 or the like during that interval.

Furthermore, when the amount of content stored in the storage unit 1013 exceeds a predetermined value, the memory control unit 1012 may effect control so as to delete or overwrite the recorded content from the storage unit 1013 starting with the oldest content. At this time, when the transmitting and receiving unit 1014 reads content starting with the interruption location from the storage unit 1013 and that content is already overwritten, transmission begins with the oldest part of the corresponding content which was not overwritten.

(3-3) Storage Unit

The storage unit 1013 is a recording device having a predetermined capacity and stores the content received by the receiving unit 1011 under the control of the memory control unit 1012. The storage unit 1013 is, for example a recording device such as a hard disk device, optical disk device, semiconductor memory, or the like.

The storage unit 1013 stores content in correspondence with absolute time, or in correspondence with relative time from the start of the content. Alternatively, the storage unit 1013 may store content in correspondence with the chapters described below.

(3-4) Transmitting and Receiving Unit

Under the control of the transmission control unit 1017, the transmitting and receiving unit 1014 transmits to the content receiving device 102 the content received by the receiving unit 1011 or the content stored in the storage unit 1013. Because the content receiving device 102 is a mobile terminal such as a portable telephone, PDA, car navigation device, or the like, the content transmission device 101 transmits the content to the content receiving device 102 over a wireless communications network 120. The transmitting and receiving unit 1014 receives, from the content receiving device 102, the status of the content receiving device 102, including the reception status of the content receiving device 102 and the user operating status of the content receiving device 102.

The transmitting and receiving unit 1014 can comprise a general device for connecting with the Internet such as a LAN (Local Area Network) adapter or the like, and software or hardware for processing communications generally used on the Internet, such as TCP/IP, RTP (Real Time Transport Protocol), or the like. RTP is a standard protocol for streaming video and speech data, and is outlined in detail in RFC1889 (Request For Comments 1889) by the IETF (Internet Engineering Task Force), and the like. The command communications and communications protocol used for the transmitting and receiving unit 1014 are not limited to the above protocols and other protocols may be used.

The constitution may also perform some type of conversion, to reduce the screen size of the content or increase the compression rate, before the content is transmitted, in consideration of the network bandwidth between the content transmission device 101 and the content receiving device 102, and the screen size or the like when the content is displayed with the content receiving device 102.

The transmitting and receiving unit 1014 may also be constituted so as to transmit different content to each of a plurality of content receiving devices 102a, 102b, etc.

(3-5) Status Monitoring Unit

The user of the content receiving device 102 cannot view and/or listen to content from an interruption location when viewing and/or listening is interrupted because the content receiving device 102 could not receive content from the content transmission device 101, or when the user himself interrupts viewing and/or listening by operating the content receiving device 102. Therefore, the interruption location is captured by the status monitoring unit 1015 in order to enable play back from the interruption location. Specifically, the status monitoring unit 1015 receives and monitors the status, such as the reception status of the content receiving device 102, which the transmitting and receiving unit 1014 receives from the content receiving device 102, the user operating status of the content receiving device 102, and the like. Based on the monitored reception status, operating status, and the like, the status monitoring unit 1015 captures and outputs the interruption location, at which the content receiving device 102 becomes unable to receive content or the user of the content receiving device 102 interrupted viewing and/or listening with the content receiving device 102, to the interruption location memory unit 1016.

(3-5-1) Interruption Location Capturing Method

The method for capturing the interruption location when content cannot be received because of the communications status of the content receiving device 102 going bad or the like, and the method for capturing the interruption location when viewing and/or listening has been interrupted by the user are described below.

(A) Capturing the Interruption Location Based on Bad Communication Status

For example, the status monitoring unit 1015 periodically transmits a control message for checking the reception status through the transmitting and receiving unit 1014 to the content receiving device 102. Then the status monitoring unit 1015 receives the response message to the control message from the content receiving device 102 through the transmitting and receiving unit 1014, and monitors the content reception status of the content receiving device 102.

Specifically, when the reception status of the content receiving device 102 is normal, the transmitting and receiving unit 1021 of the content receiving device 102 immediately returns a response message to the content transmission device 101 upon receiving a control message querying the reception status from the content transmission device 101. On the other hand, when the reception status of the content receiving device 102 becomes bad, a response message is not returned. For example, the content receiving device 102 cannot return a response message because the control message could not be received due to the bad communication status, or cannot return a response message because of the bad communication status although the control message was received. The status monitoring unit 1015 thereby captures the interruption location based on the existence of a response message. Specifically, when the status monitoring unit 1015 does not receive a response message, the interruption location is captured based on the location at which the response message could not be received. The interruption location may also be captured based on the location at which was transmitted the control message corresponding to the response message that could not be received.

The content receiving device 102 may also transmit a message in response to the reception of content instead of returning a response message in reply to the control message. For example, the status capturing method is also realized with a constitution wherein the protocol, for when the transmitting and receiving unit 1014 of the content transmission device 101 transmits content to the content receiving device 102, includes a procedure to confirm that the content receiving device 102 received the content. If such a protocol is used, the transmitting and receiving unit 1021 of the content receiving device 102 transmits a reception confirmation message to the transmitting and receiving unit 1014 upon receiving content from the transmitting and receiving unit 1014. The transmitting and receiving unit 1014 then transmits a confirmation message to the status monitoring unit 1015. On the other hand, when content cannot be received, the transmitting and receiving unit 1021 does not transmit a confirmation message to the transmitting and receiving unit 1014. The status monitoring unit 1015 thereby determines that the reception status is normal when a confirmation message is received, and when no confirmation message is received, captures the interruption location based thereon.

Also, an error detection signal is incorporated in the content transmitted by the transmitting and receiving unit 1014 to the content receiving device 102; information showing an error detection state can also be included in a response message from the content receiving device 102. Specifically, the transmitting and receiving unit 1014 of the content transmission device 101 transmits content including the error detection signal to the content receiving device 102. The transmitting and receiving unit 1021 of the content receiving device 102 calculates the error rate showing whether content was received normally from the content transmission device 101 based on the received error detection signal. The transmitting and receiving unit 1021 then transmits the calculated error rate to the transmitting and receiving unit 1014. The status monitoring unit 1015 receives the error rate from the transmitting and receiving unit 1014, and monitors error state during content reception by the content receiving device 102. For example, when the received error rate is less than or equal to a predetermined value, content reception is determined to be normal. On the other hand, when the received error rate is greater than a predetermined value, it is determined that content could not be received by the content receiving device 102 and the interruption location is captured based on the location at which the error rate in excess of the predetermined value was received. The interruption location may also be captured based on the location at which content including an error detection signal, corresponding to the received error rate in excess of the predetermined value, was transmitted.

Alternatively, the interruption location may also be captured based on the location where communication between the content transmission device 101 and the content receiving device 102 was cut off.

(B) Capturing the Interruption Location at which the User Interrupted Viewing and/or Listening

Next, the method for capturing the interruption location in the case where the user interrupted viewing and/or listening is described. The constitution may also be such that the content receiving device 102 detects whether the user himself or cannot view and/or listen to content and transmits this information to the status monitoring unit 1015 through the transmitting and receiving unit 1014 of the content transmission device 102.

For example, a portable telephone which is a content receiving device 102 detects that there is an incoming call while the user is viewing and/or listening to content with the portable telephone and transmits the detection results to the transmitting and receiving unit 1014 of the content transmission device 102. A car navigation device which is a content receiving device 102 detects whether the user is driving the vehicle in which the car navigation device is installed and transmits the detection results to the transmitting and receiving unit 1014. In other cases, the content receiving device 102 captures the interruption state of content viewing and/or listening by the user himself, such as when the user himself interrupts viewing and/or listening by operating the content receiving device 102 and transmits that information to the transmitting and receiving unit 1014. The transmitting and receiving unit 1014 then transmits the reception details from the content receiving device 102 to the status monitoring unit 1015. In this manner, when the user status is transmitted from the content receiving device 102 to the content transmission device 101, the status monitoring unit 1015 can capture the interruption location at which the content receiving device 102 became unable to receive content, as well as the interruption location at which content viewing and/or listening was interrupted at the convenience of the user of the content receiving device 102.

(3-5-2) Standards for Capturing the Interruption Location

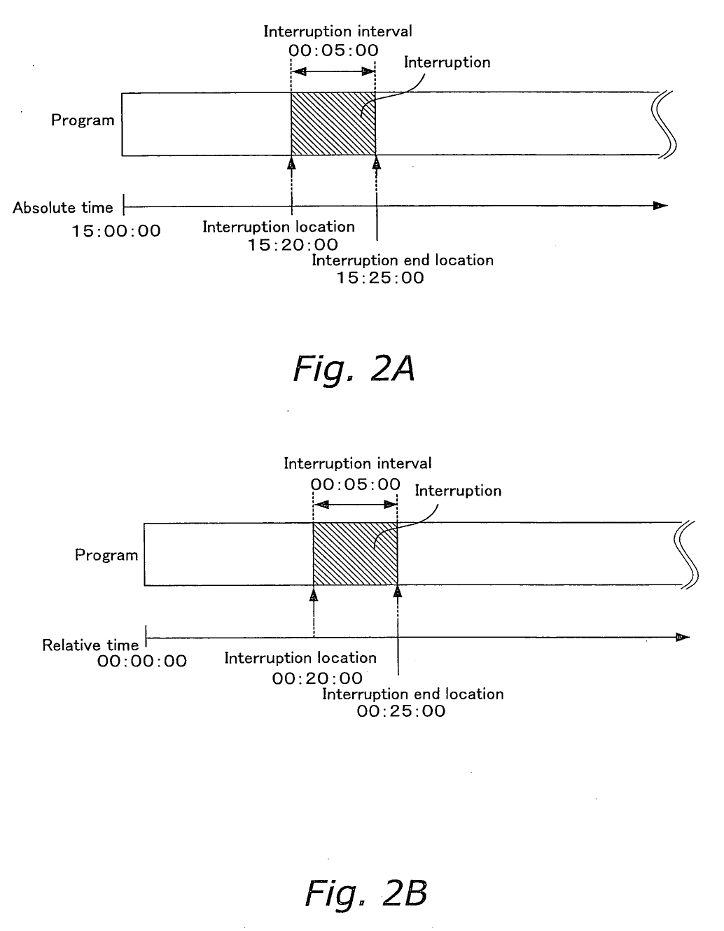

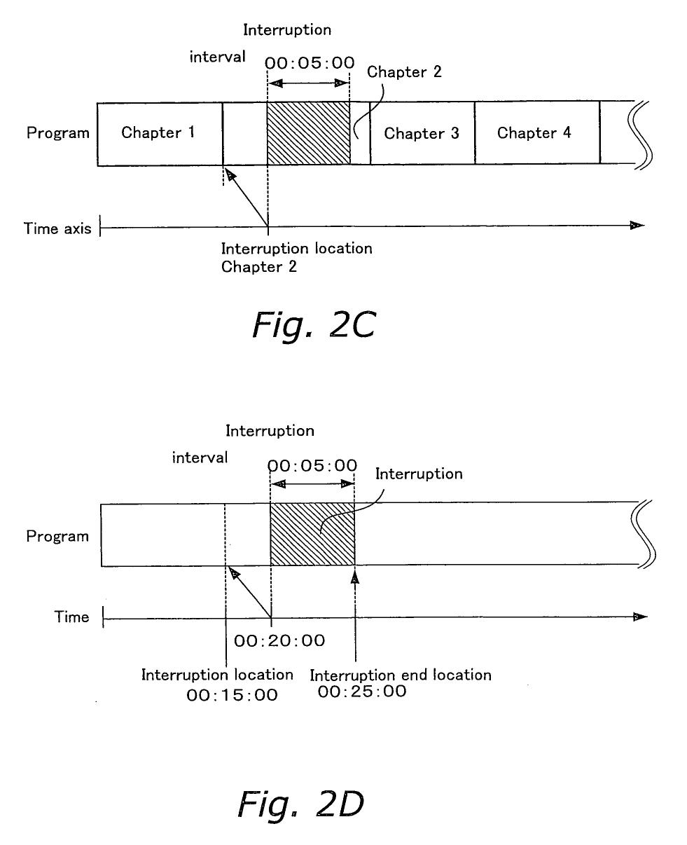

The interruption location is captured based on absolute time, relative time from the start of the program, chapters, or the like. Additionally, the interruption location may be captured as a location in advance, by a predetermined amount, of the interruption location. FIG. 2A to FIG. 2D are descriptive drawings showing methods for capturing the interruption location; the shaded portions are intervals in which viewing and/or listening with the content receiving device 102 is interrupted.

(A) Capturing Based on Absolute Time

In FIG. 2A, the interruption location is captured based on absolute time. For example, the content receiving device 102 receives a live broadcast program through the content transmission device 101 from the content distribution device 103; the viewing and/or listening of that program with the content receiving device 102 is interrupted at 15:20:00 (15:20). In this case, 15:20:00 which is an absolute time is captured as the interruption location.

(B) Capturing Based on Relative Time

In FIG. 2B, the interruption location is captured based on relative time. For example, when the program is transmitted from the content transmission device 101 and received and played back with the content receiving device 102; the interruption location is captured based on the relative time from the starting time, with the starting time at which viewing and/or listening began as the reference. As shown in FIG. 2B, the starting time of the program is 00:00:00; and viewing and/or listening with the content receiving device was interrupted at the location 00:20:00 (20 minutes) from that starting time. In this case, 00:20:00 which is a relative time from the starting time is captured as the interruption location.

(C) Capturing by Chapter

In FIG. 2C, the interruption location is captured based on the chapter including the interruption location. Here, “chapters” are the predetermined blocs into which a program, which is a unit bloc comprising content such as image data, speech data, and the like, and which is broadcast for television or the like, is divided. As shown in FIG. 2C, the program comprises chapter 1, chapter 2, etc.; when the interruption location is included in chapter 2, chapter 2 is captured as the interruption location.

(D) Capturing the Interruption Location at a Location in Advance, by a Predetermined Amount, of the Actual Interruption Location

In FIG. 2D, the interruption location is captured at a location retraced to a location in advance, by a predetermined amount, of the interruption location. For example, when the interruption location is 00:20:00 in relative time, a time of 00:15:00 which is retraced by predetermined location is captured as the interruption location. Consequently, the transmission control unit 1017 described below can perform control so that the content starting from the time of 00:15:00 retraced by predetermined location is transmitted to the content receiving device 102. The user of the content receiving device 102 can thereby view and/or listen to content from slightly prior to the interruption location and thus view and/or listen to content while grasping the flow of the content before and after the interruption location.

(3-5-3) Capturing the Interruption Reason

The status monitoring unit 1015 may also capture the interruption reason along with capturing the interruption location. Content viewing and/or listening is interrupted by the content receiving device 102 being unable to receive content due to the communications status becoming bad, due to the user receiving a telephone call while viewing and/or listening to content, or the like. In such a case, user convenience is improved by the transmission control unit 1017 described below controlling the transmission of content from the content transmission device 101 to the content receiving device 102 according to the interruption reason as well as the interruption location.

The status monitoring unit 1015 captures the interruption reason, for example, as follows. For example, as described above, when a response message in reply to a control message could not be received due to the communications status becoming bad, the status monitoring unit 1015 captures the interruption location based on the location at which the response message could not be received. At this time, the interruption reason, that “communications status went bad”, is captured along with the capture of the interruption location.

Also, the status monitoring unit 1015 may receive the interruption reason from the content receiving device 102. For example, when a telephone call comes in to the portable telephone which is the content receiving device 102 and the user takes the call, the user must stop viewing and/or listening to content with the portable telephone. At this time, as the content receiving device 102 transmits to the status monitoring unit 1015 that there was an incoming call, the status monitoring unit 1015 captures the interruption reason, “incoming call” along with the interruption location. When a user is driving a vehicle in which is installed a car navigation device which is the content receiving device 102, the user will interrupt viewing and/or listening of content with the car navigation device. At this time, as the content receiving device 102 notifies the status monitoring unit 1015 that the user is driving, the status monitoring unit 1015 captures the interruption reason “driving” along with the interruption location.

Furthermore, the status monitoring unit 1015 may also capture the interruption reason according to the type of operation performed by the user on the content receiving device 102. For example, when the user presses the Pause button on the content receiving device 102, the status monitoring unit 1015 is notified of the type of operation by the content receiving device 102. The status monitoring unit 1015 thereby captures the interruption reason “Pause button pushed.”

The status monitoring unit 1015 then outputs the captured interruption reason to the interruption location memory unit 1016.

(3-5-4) Capturing the Interruption Interval

The status monitoring unit 1015 may also capture the interruption interval along with capturing the interruption location. User convenience is thereby improved by the transmission control unit 1017, described below, controlling the transmission of content from the content transmission device 101 to the content receiving device 102, according to the interruption interval.

The capture of the interruption interval is described using FIG. 2A to FIG. 2D once again. In FIG. 2A to FIG. 2D, the shaded portions show the interval during which viewing and/or listening with the content receiving device 102 was interrupted; in the case of FIG. 2A to FIG. 2D, 00:05:00 (5 minutes) is captured as the interruption interval. The interruption end location may also be captured instead of the interruption interval itself. For example, the absolute time 15:25:00 is captured as the interruption end location in FIG. 2A; the relative time 00:25:00 is captured as the interruption end location in FIG. 2B. The interruption interval is then captured by calculating the difference from the already captured interruption location.

Specifically, the status monitoring unit 1015 captures the interruption interval as follows. The status monitoring unit 1015 measures the time from the interruption location at which a response message in reply to the control message could not be received because of the communications status going bad until the receipt of the next response message, which is to say, the time until communication restarts between the content transmission device 101 and the content receiving device 102, so as to capture the interruption interval. Alternatively, the status monitoring unit 1015 captures the time when communications restart as the interruption end location, and captures the interruption interval by calculating the difference from the interruption location already captured.

The status monitoring unit 1015 then outputs the captured interruption interval or interruption end location to the interruption location memory unit 1016.

(3-6) Interruption Location Memory Unit

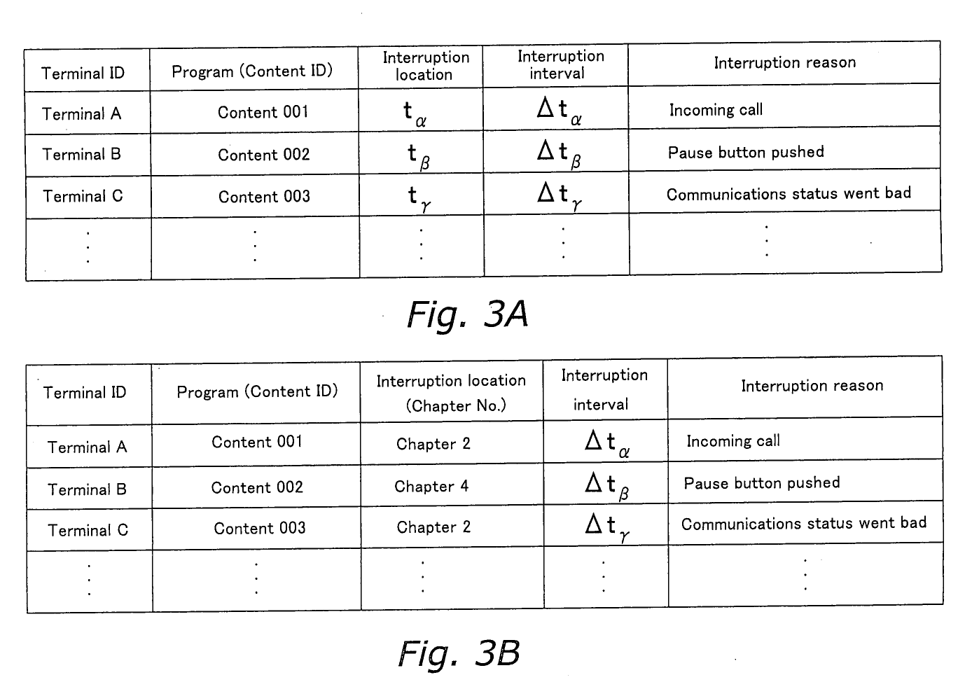

The interruption location memory unit 1016 receives and stores the interruption location, interruption reason, and interruption interval from the status monitoring unit 1015. FIG. 3A shows sample data when capturing the interruption location according to absolute time or relative time; FIG. 3B shows sample data when capturing the interruption location according to chapters. In FIG. 3A and FIG. 3B, the content ID of the interrupted program, the interruption location, interruption interval, and interruption reason are saved in a single record for each terminal ID of the content receiving devices 102. For example, for terminal A in FIG. 3A, viewing and/or listening of the content became impossible from interruption location tα for the interruption time Δtα, due to an incoming call while the user was viewing and/or listening to the content 001. For terminal A in FIG. 3B, viewing and/or listening of the content became impossible from chapter 2, which includes the interruption location, for the interruption time Δtα, due to an incoming call while the user was viewing and/or listening to the content 001. In this way, by recording the interruption location and the like, in the terminal ID of each of several content receiving devices 102 connected with the content transmission device 101, transmission control can be performed correctly for each content receiving device 102 from the interruption location in the transmission control unit 1017 described below.

(3-7) Transmission Control Unit

The transmission control unit 1017 controls the transmitting and receiving unit 1014 based on the interruption location, interruption interval, interruption reason, and the like, stored in the interruption location memory unit 1016. The transmission control unit 1017 also controls the memory control unit 1012 so that the receiving unit 1011 stores all the content received from the content distribution device 103 in the storage unit 1013. Alternatively, the transmission control unit 1017 may also control the memory control unit 1012 so that content from the interruption location is stored in the storage unit 1013 based on the interruption location captured by the status monitoring unit 1015.

Control of the transmitting and receiving unit 1014, by the transmission control unit 1017, based on the interruption location, interruption interval, interruption reason, and the like, is described next. The status monitoring unit 1015 receives the reception status, the operating status, and the like, of the content receiving device 102 through the transmitting and receiving unit 1014. Once the status monitoring unit 1015 detects that the content receiving device 102 has become able to receive or play back content, or the status monitoring unit 1015 receives a request for transmission starting at the interruption location from the content receiving device 102, the status monitoring unit 1015 transmits the detection results and a transmission request to the transmission control unit 1017. First, the transmission control unit 1017 captures the interruption location and the like from the interruption location memory unit 1016, based on the detection results and transmission requests. The transmission control unit 1017 then controls the transmitting and receiving unit 1014 so as to transmit the content in the storage unit 1013 to the content receiving device 102 based on the interruption location and the like. The transmission control unit 1017 effects control so that the transmitting and receiving unit 1014 transmits content in the storage unit 1013 based on the interruption location tα, interruption time Δtα, interruption reason “telephone call” and the like in the interruption location memory unit 1016 shown in FIG. 3A, for example. The transmission method for content based on the interruption location and the like is described next.

(A) Transmission Starting from the Interruption Location

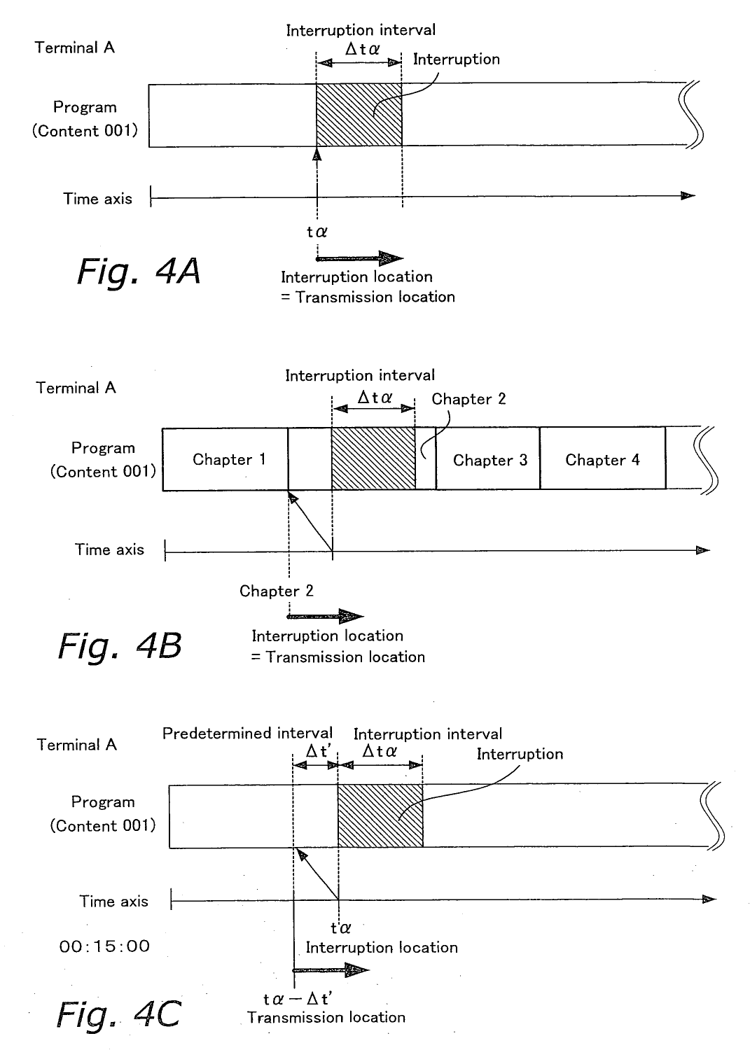

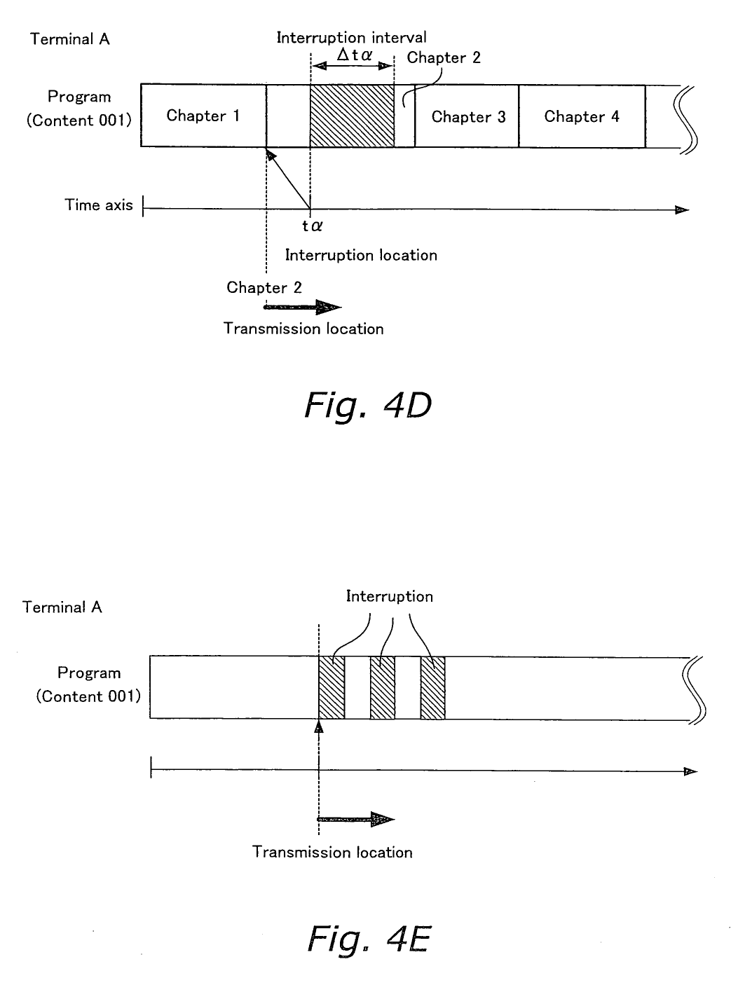

The transmission control unit 1017 controls the transmitting and receiving unit 1014 so as to transmit content starting from the interruption location in the interruption location memory unit 1016. FIG. 4A is a descriptive drawing showing the interruption location and the transmission location at which the transmitting and receiving unit starts transmitting content for the terminal A in FIG. 3A; FIG. 4B is a descriptive drawing showing the interruption location and the transmission location for the terminal A in FIG. 3B.

In FIG. 4A, the time tα is captured as the interruption location for the content 001. At this time, the transmission control unit 1017 controls the transmitting and receiving unit 1014 so as to transmit content starting from time tα to the content receiving device 102 which is the terminal A. Thus, interruption location=transmission location=tα. Then, the transmitting and receiving unit 1014 extracts the content starting at time tα from the storage unit 1013 and transmits this content to the content receiving device 102. Likewise, “chapter 2” is captured as the interruption location for “content 001” in FIG. 4B. At this time, the transmission control unit 1017 controls the transmitting and receiving unit 1014 so as to transmit the content starting from “chapter 2” to the content receiving device 102 which is the terminal A. Accordingly, interruption location=transmission location=chapter 2. Then, the transmitting and receiving unit 1014 extracts the content starting at the beginning of chapter 2 from the storage unit 1013 and transmits the content to the content receiving device 102.

(B) Transmission Starting from a Location Retraced by a Predetermined Location from the Interruption Location

The transmission control unit 1017 may also control the transmitting and receiving unit 1014 to transmit content starting from a location retraced by a predetermined location from the interruption location captured from the interruption location memory unit 1016. FIG. 4C is a descriptive drawing showing the interruption location and the transmission location at which the transmitting and receiving unit starts transmitting content for the terminal A in FIG. 3A. In FIG. 4C, the time tα is captured as the interruption location for the “content 001”. At this time, the transmission control unit 1017 controls the transmitting and receiving unit 1014 so as to transmit content, to the content receiving device 102 which is the terminal A, starting from a location retraced by a predetermined location, such as the predetermined interval Δt′, from the time tα. Accordingly, this is expressed as the transmission location=interruption location tα−predetermined location Δt′. Then, the transmitting and receiving unit 1014 extracts the content starting at time tα−Δt′ from the storage unit 1013 and transmits this content to the content receiving device 102. Because the transmitting and receiving unit 1014 of the content transmission device 101 transmits content from a point prior to the interruption location to the content receiving device 102, the user of the content receiving device 102 can view and/or listen to content while grasping the flow of the content before and after the interruption location.

(C) Transmission Starting from the Chapter Including the Interruption Location

The transmission control unit 1017 may also control the transmitting and receiving unit 1014 so as to transmit content starting from the chapter including the interruption location in the interruption location memory unit 1016. FIG. 4D is a descriptive drawing showing the interruption location and the transmission location at which the transmitting and receiving unit starts transmitting content for the terminal A in FIG. 3A. In FIG. 4D, the time tα is captured as the interruption location for the “content 001”. At this time, the transmission control unit 1017 controls the transmitting and receiving unit 1014 so as to transmit content starting from “chapter 2”, including the time tα, which is the interruption location, to the content receiving device 102 which is the terminal A. Then, the transmitting and receiving unit 1014 extracts the content starting from the beginning of “chapter 2” from the storage unit 1013 and transmits the content to the content receiving device 102. In this manner, as the transmitting and receiving unit 1014 transmits content according to the chapter, the user of the content receiving device 102 can view and/or listen to content from a better stopping place than the interruption location itself.

Note that the transmission control unit 1017 may also determine whether to control so as to transmit content from the chapter including the interruption location, according to the distance between the interruption location and the chapter. For example, when the interruption location is near the starting location of the chapter, the transmitting and receiving unit 1014 is controlled so as to transmit content starting from that chapter. On the other hand, when the interruption location is near the ending location of the chapter, the transmitting and receiving unit 1014 is controlled so as to transmit content from the interruption location.

(D) Transmission According to the Interruption Reason

The transmission control unit 1017 may control the transmitting and receiving unit 1014 so as to transmit content based on the interruption reason in the interruption location memory unit 1016. For example, the transmission control unit 1017 determines the predetermined location retraced from the interruption location for each interruption reason, such as whether the user of the content receiving device 102 is driving or engaged in a telephone call. This is set by the transmission control unit 1017. The transmission control unit 1017 controls the transmitting and receiving unit 1014 so as to transmit content from a location retraced by a predetermined location from the interruption location, based on the interruption reason, to the content receiving device 102. The transmission control unit 1017 may also store the retrace time for each interruption reason in a table established in advance.

For example, when the interruption reason is interruption due to “a telephone call”, the transmission control unit 1017 determines a location retraced a relatively long way from the interruption location, and controls the transmitting and receiving unit 1014 according to that determination. The transmitting and receiving unit 1014 transmits content from the location retraced by the amount determined by the transmission control unit 1017 to the content transmission device 102. When the user interrupts content viewing and/or listening with the content receiving device 102 by engaging in a telephone call, the user is very likely to forget the content viewed and/or listened to prior to the telephone call. The user can view and/or listen to content while grasping the flow of the content before and after the interruption location because of the transmitting and receiving unit 1014 of the content transmission device 101 transmitting content considerably prior to the interruption location. Thus, determining the predetermined location to retrace from the interruption location according to the interruption reason can provide improved convenience when the user uses the content receiving device 102.

(E) Transmission According to the Interruption Interval

The transmission control unit 1017 may control the transmitting and receiving unit 1014 so as to transmit content based on the interruption interval in the interruption location memory unit 1016. For example, due to the high probability that content viewed and/or listened to prior to the interruption will be forgotten in the case of longer interruption intervals, the transmission control unit 1017 determines a long time to retrace from the interruption location corresponding to the length of the interruption interval, and controls the transmitting and receiving unit 1014 according to that determination. As shown in FIG. 4E, when there are several short interruption intervals over a short period of time, the transmission control unit 1017 may control the transmitting and receiving unit 1014 so as to transmit content starting from the first interruption location. In the case of FIG. 4E, the user can view and/or listen to content while grasping the flow of the content as content is transmitted from the first interruption location, rather than from each interruption location.

As shown in (A) through (E) above, the content receiving device 102 can receive and play back content from an interruption location as the transmitting and receiving unit 1014 transmits content corresponding to the interruption location. Accordingly, a user viewing and/or listening to the content with the content receiving device 102, or the content receiving device 102 and content transmission device 101 can, himself, instantly play back the content corresponding to the interruption location on the content receiving device 102 without searching for the interruption location. The user of the content receiving device 102 can therefore instantly resume viewing and/or listening to content starting from the interruption location, and can also view and/or listen to interrupted content during short intervals of free time, such as while waiting for a train.

Also, when the transmission control unit 1017 controls the transmitting and receiving unit 1014 so as to read the data in the storage unit 1013 starting from the interruption location and transmit the data to the content receiving device 102, the transmission control unit 1017 may also control so as to transmit at higher speeds than usual. The content receiving device 102 thereby receives content at higher speeds than usual. Accordingly, the user can confirm missed portions by fast-forwarding, and catch up to the content presently being transmitted by the content distribution device 103. Also, at this time, when the transmitting and receiving unit 1014 reads content at higher speeds than usual and the receiving unit 1011 catches up to the content presently being received from the content distribution device 103, the transmission control unit 1017 commands the transmitting and receiving unit 1014 to transmit the data received by the receiving unit 1011. Furthermore, when the transmission control unit 1017 commands the memory control unit 1012 to stop storing content continuing from the interruption location in the storage unit 1013, the volume of the content stored in the storage unit 1013 can be minimized.

(4) Content Receiving Device

Next, the content receiving device 102 is described in detail. The content receiving device 102 is a mobile terminal which can transmit and receive data through wireless communications, such as a portable telephone, and comprises a transmitting and receiving unit (1021a, 1021b, etc.) 1021 and a display unit (1022a, 1022b, etc.) 1022.

(4-1) Transmitting and Receiving Unit

The transmitting and receiving unit 1021 can comprise software or hardware for processing communications protocols for wireless communications, and communicates with the transmitting and receiving unit 1014 of the content transmission device 101 over a wireless communications network 120. The transmitting and receiving unit 1021 receives content and control messages transmitted by the content transmission device 101. Furthermore, the transmitting and receiving unit 1021 transmits, to the status monitoring unit 1015, the response messages corresponding to the control messages, the error detection signal, the operating situation and the interruption reason for the content receiving device 102, and the like. Furthermore, when the user resumes viewing and/or listening by operating the content receiving device 102, a resumption notification is transmitted to the status monitoring unit 1015.

For example, the transmitting and receiving unit 1021 receives a control message, periodically transmitted by the status monitoring unit 1015, through the transmitting and receiving unit 1014. The transmitting and receiving unit 1021 then transmits a response message for the control message to the status monitoring unit 1015 through the transmitting and receiving unit 1014 of the content transmission device 101. The status monitoring unit 1015 monitors the reception status of the content receiving device 102 according to whether a response message was received, and captures the interruption location, interruption reason, interruption interval, and the like.

When the transmitting and receiving unit 1021 receives content including an error detection signal from the transmitting and receiving unit 1014, a response message including information showing the error detection status is transmitted to the transmitting and receiving unit 1014. The status monitoring unit 1015 monitors the reception status in the content receiving device 102 based on the error rate included in the information showing the error detection status, and captures the interruption location, interruption reason, interruption interval, and the like.

Furthermore, the transmitting and receiving unit 1021 detects that there is a call incoming to the portable telephone which is the content receiving device 102, detects that the car equipped with the car navigation device which is the content receiving device 102 is being driven, and detects the operation of the content receiving device 102 by the user himself. The transmitting and receiving unit 1021 then transmits these detection results to the status monitoring unit 1015 through the transmitting and receiving unit 1014. By receiving this detection information, the status monitoring unit 1015 monitors the status of operations by the user and captures the interruption location, interruption reason, interruption interval, and the like.

(4-2) Display Unit

The display unit 1022 plays back and displays to the user the content received by the transmitting and receiving unit 1021. The display unit 1022 can be constituted using display devices such as liquid crystal, speakers, and the like, and software and hardware for expanding and decoding compressed and digitally encoded content data.

(5) Flow of Content Transmission in the Content Transmitting and Receiving System

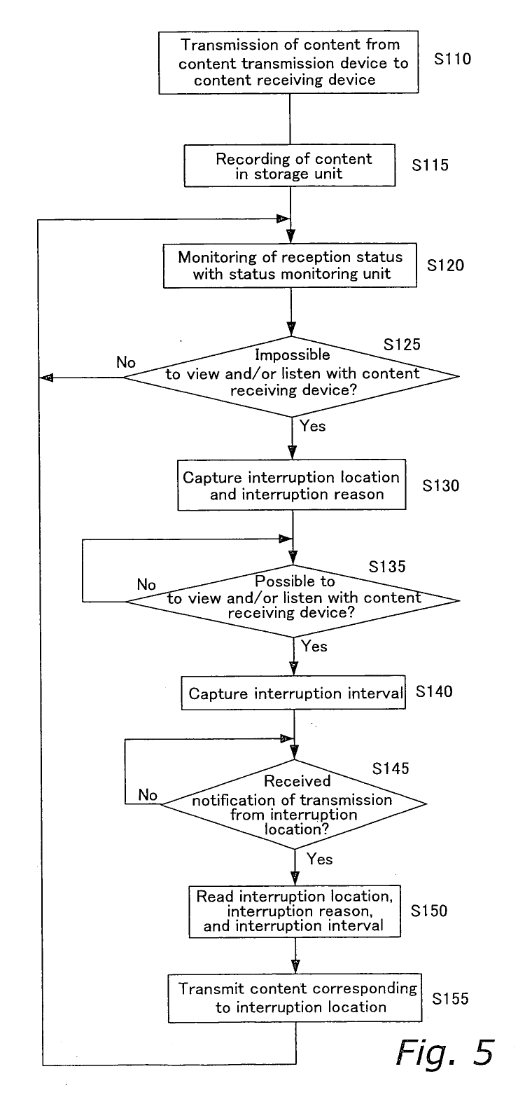

Next is described the flow of content transmission in the content transmitting and receiving system 100, in the case of an interruption in the viewing and/or listening of content with the content receiving device 102. FIG. 5 is an example of a flowchart showing the flow of content transmission in the content transmitting and receiving system.

Step S110: The transmission control unit 1017 controls the transmitting and receiving unit 1014 of the content transmission device 101 so as to transmit content to the transmitting and receiving unit 1021 of the content receiving device 102. At this time, the transmitting and receiving unit 1014 may transmit content received by the receiving unit 1011 from the content distribution device 103 to the transmitting and receiving unit 1021, and may transmit content stored in the storage unit 1013 to the transmitting and receiving unit 1021.

Step S115: The transmission control unit 1017 controls the memory control unit 1012 so as to store content received by the receiving unit 1011 in the storage unit 1013. The transmission control unit 1017 may also control the memory control unit 1012 so that content starting from the interruption location is stored in the storage unit 1013 based on the interruption location captured by the status monitoring unit 1015.

Step S120: The status monitoring unit 1015 monitors status, such as the reception status, operating status, and the like of the content receiving device 102. For example, the status monitoring unit 1015 monitors status, such as the reception status and operating status, by receiving response messages to control messages, receiving response messages including error detection signals, receiving signals showing that the content receiving device 102 has been operated, and the like.

Step S125: The status monitoring unit 1015 determines whether viewing and/or listening with the content receiving device 102 has become impossible based on the captured status. For example, the status monitoring unit 1015 determines that the user has become unable to view and/or listen to content with the content receiving device 102, when the status monitoring unit 1015 cannot receive a response message, receives a response message that the error rate exceeds a predetermined value, or the status wherein the user becomes unable to view and/or listen to content due to receiving an incoming call or driving a vehicle. The process advances to Step S130 when the status monitoring unit 1015 determines that viewing and/or listening with the content receiving device 102 has become impossible. On the other hand, the process returns to Step S120 when the status indicating that viewing and/or listening is possible continues.

Step S130: The status monitoring unit 1015 captures the interruption location and interruption reason at the time when viewing and/or listening with the content receiving device 102 became impossible. The interruption location memory unit 1016 stores the interruption location and interruption reason.

Step S135: The status monitoring unit 1015 continues to monitor status and determines whether the status has changed from viewing and/or listening with the content receiving device 102 being impossible to viewing and/or listening being possible. The process advances to Step S140 when the status monitoring unit 1015 determines that viewing and/or listening with the content receiving device 102 has become possible. On the other hand, status monitoring continues when the status that content cannot be viewed and/or listened to continues.

Step S140: The status monitoring unit 1015 captures the interruption interval in response to viewing and/or listening with the content receiving device 102 becoming possible. The interruption interval can be captured by calculating the difference between the already captured interruption location and the location where viewing and/or listening became possible.

Step S145, S150: When the status monitoring unit 1015 receives a request to transmit content starting from the interruption location to the content transmission device from the transmitting and receiving unit 1021, the transmission control unit 1017 reads the interruption location, interruption reason, and interruption interval from the interruption location memory unit 1016.

Step S155: The transmission control unit 1017 controls the transmitting and receiving unit 1014 so as to transmit content in the storage unit 1013 to the content receiving device 102 based on the interruption location that was read or the like.

(6) Operation and Effect

In the first embodiment, when the content receiving device 102 fails to receive the content, the content transmission device 101 transmits to the content receiving device 102 content corresponding to the interruption location of the reception failure. Alternatively, when the user of the content receiving device 102 interrupts viewing and/or listening of content with the content receiving device 102, the content transmission device 101 transmits to the content receiving device 101 the content corresponding to the interruption location at which viewing and/or listening was interrupted. Accordingly, a user viewing and/or listening to the content with the content receiving device 102, or the content receiving device 102 and content transmission device 101 can, himself, instantly play back the content corresponding to the interruption location on the content receiving device 102 without searching for the interruption location. The user of the content receiving device 102 can therefore instantly resume viewing and/or listening to content starting from the interruption location, and can also view and/or listen to interrupted content during short intervals of free time, such as while waiting for a train.

Furthermore, because the content transmission device 101 transmits content corresponding to the interruption location to the content receiving device 102, the content receiving device 102 can play back content which could not be received or content interrupted by the user, just by playing back received content. In effect, it is not necessary for the content receiving device 102 to store content, or to search the stored content for content corresponding to the interruption location. It is thereby possible to improve the convenience of the user using the content receiving device 102 without increasing the complexity of the constitution of the content receiving device 102.

For example, when the content receiving device 102 is a mobile terminal, reception status is unstable, as the reception environment of the mobile terminal changes at any time, and failures often occur in the reception. Also, the user of the mobile terminal is inevitably interrupted in his viewing and/or listening of content with the mobile terminal due to the constant change of the usage environment of the mobile terminal. In such a case, viewing and/or listening can be resumed from the interruption location in the content transmission device, without the content transmission device 101, the content receiving device 102, or the user himself searching for the interruption location. As described above, by virtue of the invention set forth above, a content transmission device can be provided, which is optimal for the usage environment of a mobile terminal.

Moreover, the reception unit in the claims corresponds to the receiving unit 1011; the storage unit corresponds to the storage unit 1013; the transmission unit in the claims corresponds to the transmitting and receiving unit 1014; the interruption location capturing unit corresponds to the status monitoring unit 1015 and the interruption location memory unit 1016; and the transmission controlling unit corresponds to the transmission control unit 1017.

### Second Embodiment

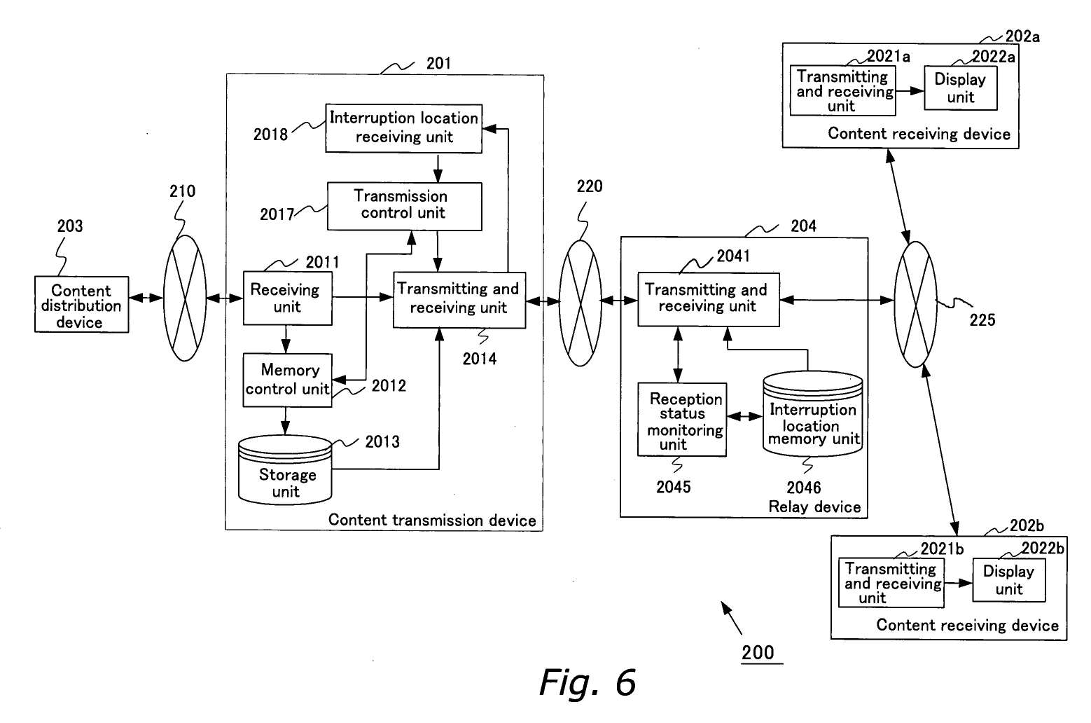

FIG. 6 is a block diagram showing a content transmitting and receiving system 200 according to a second embodiment of the present invention.

(1) Overall Constitution

The content transmitting and receiving system 200 comprises a content transmission device 201, a content receiving device (202a, 202b, etc.)202, a content distribution device 203, and a relay device 204. The content distribution device 203 is connected with the content transmission device 201 through a communications network 210. The content transmission device 201 and the content receiving device 202 are connected via a wireless communications network 220 and a wireless communications network 225. Also, the wireless communications between the content transmission device 201 and the content receiving device 202 are carried out via the relay device 204. The content transmitting and receiving system 200 according to the second embodiment differs from the content transmitting and receiving system 100 according to the first embodiment, in that the interruption location, interruption reason, and interruption interval are captured and stored in the relay device 204, and in that the content transmission device 201 transmits content to the content receiving device 202 based on the interruption location and the like stored in the relay device 204.

The constitutions of the content transmission device 201, content receiving device 202, and the relay device 204 are described in detail below. The content distribution device 203 has the same constitution as the content distribution device 103 in the first embodiment and a description thereof is omitted. First, the constitution of the relay device 204 is described.

(2) Relay Device

The relay device 204 comprises a transmitting and receiving unit 2041, a status monitoring unit 2045, and an interruption location memory unit 2046. The relay device may be a router or bridge, for example.

(2-1) Transmitting and Receiving Unit

The transmitting and receiving unit 2041 of the relay device 204 relays wireless communications between the content transmission device 201 and the content receiving device 202 based on a routing table for relaying wireless communications, for example. At this time, content received from the transmitting and receiving unit 2014 of the content transmission device 201 is transmitted to the transmitting and receiving unit 2021 of the content receiving device 202 through the transmitting and receiving unit 2041 of the relay device 204.

And the transmitting and receiving unit 2041 receives the status, including the reception status and operating status of the content receiving device 202, from the content receiving device 202. Furthermore, the transmitting and receiving unit 2041 transmits the interruption location, interruption reason, and interruption interval stored in the interruption location memory unit 2046, described below, to the content transmission device 201.

(2-2) Status Monitoring Unit

When viewing and/or listening is interrupted because the content receiving device 202 could not receive content from the content transmission device 201, or when the user himself interrupts viewing and/or listening by operating the content receiving device 202, the user of the content receiving device 202 cannot view and/or listen to content from the interruption location. Therefore, the interruption location is captured by the status monitoring unit 2045 in order to enable play back of content from the interruption location. Specifically, the status monitoring unit 2045 receives and monitors the status, including the reception status and operating status of the content receiving device 202 received by the transmitting and receiving unit 2041 from the transmitting and receiving unit 2021 of the content receiving device 202. The status monitoring unit 2045 captures, based on the monitored status, the interruption location at which the content receiving device 202 became unable to receive content or the interruption location at which the user of the content receiving device 202 interrupted viewing and/or listening with the content receiving device 202, and outputs the interruption location to the interruption location memory unit 2046.

The method for capturing the interruption location with the status monitoring unit 2045 is the same as in the first embodiment. For example, the status monitoring unit 2045 periodically transmits a control message for checking the reception status through the transmitting and receiving unit 2041 to the content receiving device 202. The status monitoring unit 2045 then captures the interruption location based on whether there is a response message to the control message. Furthermore, as in the first embodiment, the status monitoring unit 2045 captures the interruption reason and interruption interval corresponding to the reception status of the content receiving device 202.

(2-3) Interruption Location Memory Unit

The interruption location memory unit 2046 receives and stores the interruption location, interruption reason, and interruption interval from the status monitoring unit 2045.

(3) Content Receiving Device

Next, the content receiving device (202a, 202b) 202 is described in detail. The content receiving device 202 comprises a transmitting and receiving unit (2021a, 2021b) 2021 and a display unit (2022a, 2022b) 2022. The transmitting and receiving unit 2021 receives content, control messages, and the like transmitted by the content transmission device 201 through the relay device 204. Furthermore, the transmitting and receiving unit 2021 transmits to the status monitoring unit 2045 the response messages corresponding to the control messages, the error detection signal, the operating status of the content receiving device 202, interruption reason, and resumption notification, and the like. The display unit 2022 plays back and displays to the user the content received by the transmitting and receiving unit 2021.

(4) Content Transmission Device

The content transmission device 201 comprises a receiving unit 2011, a memory control unit 2012, a storage unit 2013, a transmitting and receiving unit 2014, a transmission control unit 2017, and an interruption location receiving unit 2018.

The interruption location receiving unit 2018 captures the interruption location, interruption reason, and interruption interval from the interruption location memory unit 2046 through the transmitting and receiving unit 2041 of the relay device 204. The transmission control unit 2017 then effects control so that the transmitting and receiving unit 2014 transmits content in the storage unit 2013 to the content receiving device 202 based on the interruption location and the like captured by the interruption location receiving unit 2018.

The constitutions of the receiving unit 2011, the memory control unit 2012, the storage unit 2013, the transmitting and receiving unit 2014, and the transmission control unit 2017 are the same as in the first embodiment and descriptions thereof are omitted; the interruption location receiving unit 2018 is described in detail.

Once the status monitoring unit 2045 detects that the content receiving device 202 has become able to receive or play back content, or the status monitoring unit 2045 receives a request for transmission starting at the interruption location from the content receiving device 202, the interruption location, interruption reason, and interruption interval in the interruption location memory unit 2046 are transmitted to the interruption location receiving unit 2018. The interruption location receiving unit 2018 therefore captures the interruption location and the like through the transmitting and receiving unit 2041. Also, when the content starting from the interruption location is stored in the storage unit 2013, the interruption location receiving unit 2018 receives the interruption location from the transmitting and receiving unit 2041 at the same time that the status monitoring unit 2045 captures the interruption location. The transmission control unit 2017 may then capture the interruption location from the interruption location receiving unit 2018 and control the memory control unit 2012 to store the content starting from the interruption location in the storage unit 2013.

(5) Operation and Effect

In the second embodiment, as in the first embodiment, when viewing and/or listening with the content receiving device 202 becomes impossible because of the communications status going bad or interruption by the user himself, the user viewing and/or listening to content with the content receiving device 202, or the content receiving device 202 and content transmission device 201 can instantly play back content corresponding to the interruption location in the content receiving device 202 without searching for the interruption location. The user of the content receiving device 202 can therefore instantly resume viewing and/or listening to content starting from the interruption location.

Moreover, it is not necessary for the content receiving device 202 to store content, or to search the stored content for content corresponding to the interruption location. It is thereby possible to improve the convenience of the user using the content receiving device 202 without increasing the complexity of the constitution of the content receiving device 202.

As described above, by virtue of the invention set forth above, a content transmission device can be provided, which is optimal for the usage environment of a mobile terminal in which the reception status easily becomes unstable.

### Third Embodiment

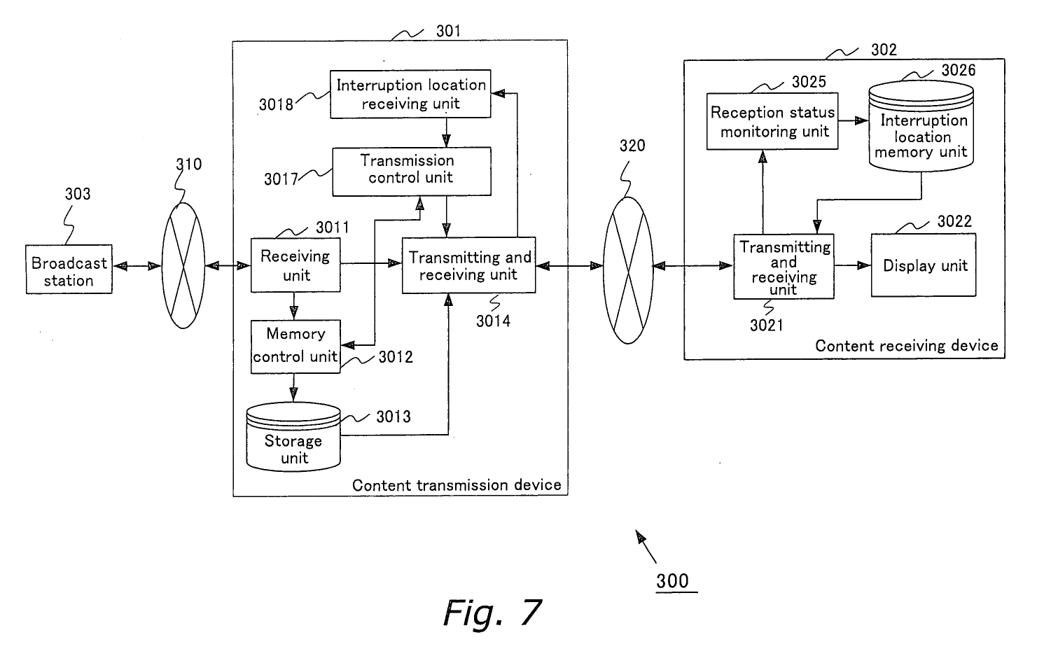

FIG. 7 is a block diagram showing a content transmitting and receiving system 300 according to a third embodiment of the present invention.

(1) Overall Constitution

The content transmitting and receiving system 300 comprises a content transmission device 301, content receiving device (302a, 302b, etc.) 302, and a content distribution device 303. The content distribution device 303 is connected with the content transmission device 301 through a communications network 310. The content transmission device 301 and the content receiving device 302 are connected via a wireless communications network 320. The content transmitting and receiving system 300 according to the second embodiment differs from the content transmitting and receiving system 100 according to the first embodiment in that the interruption location, interruption reason, and interruption interval are captured and stored in the content receiving device 302, and in that the content transmission device 301 transmits content to the content receiving device 302 based on the interruption location and the like stored in the content receiving device 302.

The constitutions of the content transmission device 301 and the content receiving device 302 are described in detail below. The content distribution device 303 has the same constitution as the content distribution device 103 in the first embodiment and a description thereof is omitted. First, he constitution of the content receiving device 302 is described.

(2) Content Receiving Device

The content receiving device (302a, 302b) 302 comprises a transmitting and receiving unit (3021a, 3021b) 3021, a display unit (3022a, 3022b) 3022, a status monitoring unit 3025, and an interruption location memory unit 3026.

(2-1) Transmitting and Receiving Unit

The transmitting and receiving unit 3021 receives content, control messages, and the like from the content transmission device 301. In addition, the transmitting and receiving unit 3021 notifies the status monitoring unit 3025 that viewing and/or listening is interrupted because content could not be received from the content transmission device 201. The transmitting and receiving unit 3021 also notifies the status monitoring unit 3025 when reception of content from the content transmission device 201 is resumed. Furthermore, the transmitting and receiving unit 3021 transmits the interruption location, interruption reason, and the interruption interval stored in the interruption location memory unit 3026 to the content transmission device 301.

(2-2) Status Monitoring Unit

When viewing and/or listening is interrupted because the transmitting and receiving unit 3021 of the content receiving device 302 cannot receive content from the content transmission device 301, the status monitoring unit 3025 is notified of the interruption by the transmitting and receiving unit 3021. When the user of the content receiving device 302 operates the content receiving device 302, or the like, and interrupts viewing and/or listening by himself, the status monitoring unit 3025 detects that operation. For example, when the user responds to a call incoming to the content receiving device 302 or performs an operation that interrupts reception of content with the content receiving device 302, the status monitoring unit 3025 detects the operating status of the content receiving device 302. Upon receiving notification of the interruption from the transmitting and receiving unit 3021, the status monitoring unit 3025 captures the time at which the notification was received as the interruption location, along with the interruption reason “bad communication”. Upon monitoring the operating status of the content receiving device 302 and detecting a user operation to interrupt viewing and/or listening with the content receiving device 302, the status monitoring unit 3025 captures the detection time as the interruption location, along with an interruption reason depending on the type of operation, such as “interruption by an incoming call.”

Furthermore, upon being notified by the transmitting and receiving unit 3021 that reception of content has been resumed, the status monitoring unit 3025 captures the interruption interval based on the time at which that notification was received. Upon detecting a user operation to resume viewing and/or listening by monitoring the operating status of the content receiving device 302, the status monitoring unit 3025 captures the interruption interval based on that detection time.

The status monitoring unit 3025 transmits the captured interruption location, interruption reason, and interruption interval to the interruption location memory unit 3026.

(2-3) Interruption Location Memory Unit

The interruption location memory unit 3026 receives and stores the interruption location, interruption reason, and interruption interval from the status monitoring unit 3025.

(3) Content Transmission Device

The content transmission device 301 comprises a receiving unit 3011, a memory control unit 3012, a storage unit 3013, a transmitting and receiving unit 3014, a transmission control unit 3017, and an interruption location receiving unit 3018.

The interruption location receiving unit 3018 captures the interruption location, interruption reason, and interruption interval from the interruption location memory unit 3026 in the content receiving device 302. The transmission control unit 3017 then effects control so that the transmitting and receiving unit 3014 transmits content in the storage unit 3013 to the content receiving device 302, based on the interruption location and the like captured by the interruption location receiving unit 3018.

The constitutions of the receiving unit 3011, memory control unit 3012, storage unit 3013, transmitting and receiving unit 3014, and transmission control unit 3017 are the same as in the first embodiment and descriptions thereof are omitted; the interruption location receiving unit 3018 is described in detail.

When the status monitoring unit 3025 receives a notification that reception of content has resumed from the transmitting and receiving unit 3021 or detects a user operation to resume viewing and/or listening and a request to transmit content starting from the interruption location, the status monitoring unit 3025 transmits the interruption location, interruption reason, and interruption interval in the interruption location memory unit 3026 to the interruption location receiving unit 3018. The interruption location receiving unit 3018, therefore captures the interruption location and the like through the transmitting and receiving unit 3041.

Also, when the content starting from the interruption location is stored in the storage unit 3013, the interruption location receiving unit 3018 receives the interruption location from the transmitting and receiving unit 3041 at the same time that the status monitoring unit 3025 captures the interruption location. The transmission control unit 3017 may also control the memory control unit 3012 so that content starting from the interruption location is stored in the storage unit 3013 based on the interruption location captured by the status monitoring unit 3025.

(5) Operation and Effect

In the third embodiment, as in the first embodiment, when viewing and/or listening with the content receiving device 202 sic becomes, the user viewing and/or listening to content with the content receiving device 302, or the content receiving device 302 and content transmission device 301 can instantly play back content corresponding to the interruption location in the content receiving device 302 without searching for the interruption location. The user of the content receiving device 302 can therefore instantly resume viewing and/or listening to content starting from the interruption location.

As described above, by virtue of the invention set forth above, a content transmission device can be provided, which is optimal for the usage environment of a mobile terminal in which the reception status easily becomes unstable.

### Other Embodiments

(A) Modification 1

The preceding embodiments show examples wherein content is received via a content transmission device, even when the content receiving device receives the content currently broadcast by the content distribution device. However, when receiving content currently broadcast by the content distribution device, the content receiving device may also receive the broadcast directly from the content distribution device. The device may also be controlled so that the device connects with the content transmission device and content stored in the storage unit is transmitted starting from the interruption location, only when one wishes to view and/or listen to content starting from the interruption location.

(B) Modification 2

In the preceding embodiments, the content transmission device transmits content received from the content distribution device to the content receiving device. However, content stored in the content transmission device in advance may also be transmitted to the content receiving device.

(C) Modification 3

Content is correlated with time information such as absolute time or relative time and stored in the storage unit; and content is correlated with chapter and time information and stored in a separate location such as on a web server. When the status monitoring unit captures the interruption location based on the chapter, the transmission control unit captures the time information corresponding to the captured chapter from the web server or the like. The transmission control unit may also transmit content starting from the interruption location based on the time information corresponding to the captured interruption location.

(D) Modification 4

The content distribution device may also distribute content upon request from the content receiving device. For example, the content distribution device receives content identification information from the content receiving device and distributes content corresponding to that identification information.

(E) Modification 5

The preceding embodiments show examples wherein content is received from one content distribution device, but the invention may also be constituted so as to receive content from a plurality of content distribution devices.

(F) Modification 6

The present invention includes a program for executing processes for the embodiments described above on a computer, and a computer-readable storage medium storing that program. The storage medium may be a computer-readable flexible disk, a hard disk, a semiconductor memory, a CD-ROM, a DVD, a DVD-ROM, a DVD-RAM, a BD (Blu-ray Disc), a magneto-optical disk (MO), or the like.

### INDUSTRIAL APPLICABILITY

By virtue of the invention set forth above, a content transmission device can be provided, which is optimal for the usage environment of a mobile terminal in which the reception status easily becomes unstable.

1. A content transmission device connected with a content receiving device over a network, comprising:
a storage unit configured to store content;
a transmission unit configured to transmit content to said content receiving device;
a interruption location capturing unit configured to capture an interruption location at which said content receiving device became unable to receive content, or an interruption location at which the user of said content receiving device interrupted viewing and/or listening with said content receiving device; and
a transmission controlling unit configured to control said transmission unit so as to transmit content in said storage unit to said content receiving device based on the interruption location captured by said interruption location capturing unit.

2. The content transmission device recited in claim 1, wherein said interruption location capturing unit further comprises a status monitoring unit configured to receive and monitor the status of said content receiving device from said content receiving device, while capturing the interruption location based on said status.

3. The content transmission device recited in claim 1, wherein said status monitoring unit receives notification that reception of content has become impossible from said content receiving device, and captures the interruption location based on said notification.

4. The content transmission device recited in claim 2, wherein said status monitoring unit detects that the error rate of communications with said content receiving device has exceeded a predetermined value, and captures the interruption location based on those detection results.

5. The content transmission device recited in claim 2, wherein said status monitoring unit detects that communication between said content transmission device and said content receiving device has been cut off, and captures the interruption location based on those detection results.

6. The content transmission device recited in claim 1, wherein said interruption location capturing unit captures said interruption location based on the time at which said content receiving device became unable to receive content or the time at which the user of said content receiving device interrupted viewing and/or listening with said content receiving device.

7. The content transmission device recited in claim 1, wherein said content comprises a plurality of chapters, and said interruption location capturing unit captures the interruption location in chapter units.

8. The content transmission device recited in claim 1, wherein said transmission controlling unit controlls said transmission unit so as to transmit content starting from said interruption location to said content receiving device.

9. The content transmission device recited in claim 1, wherein said transmission controlling unit controls said transmission unit so as to transmit content to said content receiving device starting from a predetermined location in advance, by a predetermined amount, of said interruption location.

10. The content transmission device recited in claim 1, wherein said content comprises a plurality of chapters;
said interruption location capturing unit captures as the interruption location the chapter including the location at which said content receiving device became unable to receive content, or the location at which the user of said content receiving device interrupted viewing and/or listening with said content receiving device; and
said transmission controlling unit controls said transmission unit so as to transmit content to said content receiving device starting from the beginning of the chapter captured by said interruption location capturing unit.

11. The content transmission device recited in claim 1, wherein said interruption location capturing unit captures the interruption reason for which the content receiving device became unable to receive content, or the interruption reason for which the user of said content receiving device interrupted viewing and/or listening with said content receiving device; and
said transmission controlling unit determines the predetermined distance to retrace from the interruption location according to said interruption reason, and controls said transmission unit to transmit content starting from the predetermined distance determined to said content receiving device.

12. The content transmission device recited in claim 1, further comprising:
a receiving unit configured to receive content from the exterior; and
a memory controlling unit configured to perform control so that content received by said receiving unit is stored in said storage unit starting from the interruption location captured by said interruption location capturing unit.

13. The content transmission device recited in claim 12, wherein said memory controlling unit performs control so that said transmission unit transmits content to the content receiving device based on said interruption location, while said storage unit stores content received by said receiving unit.

14. The content transmission device recited in claim 2, wherein said status monitoring unit notifies said transmission controlling unit of detection results upon detecting that said content receiving unit has become able to receive or play back content; and
said transmission controlling unit controls said transmission unit so as to transmit content of said storage unit to said content receiving device based on said detection results.

15. The content transmission device recited in claim 2, wherein said status monitoring unit, upon receiving a request for transmission starting from said interruption location from said content receiving device, notifies said transmission controlling unit of said transmission request; and
said transmission controlling unit controls said transmission unit so as to transmit the content in said storage unit to said content receiving device based on the notification of said transmission request.

16. A content transmission method for a content transmission device connected with a content receiving device over a network, comprising the steps of:
storing content;
transmitting content to said content receiving device;
capturing the interruption location at which said content receiving device became unable to receive content, or the interruption location at which the user of said content receiving device interrupted viewing and/or listening with said content receiving device; and
performing control so as to transmit content stored in said storage step to said content receiving device based on the interruption location captured in said interruption location capture step.
